(19) United States
(12) Patent Application Publication
(10) Pub. No.: US 2024/0332557 A1
(43) Pub. Date: Oct. 3, 2024

(54) HUMIDIFIER

(71) Applicant: AISIN CORPORATION, Kariya (JP)

(72) Inventors: Shogo FUKAMI, Kariya-shi (JP); Koichi Kashiwagi, Kariya-shi (JP); Shohei Masuda, Kariya-shi (JP)

(73) Assignee: AISIN CORPORATION, Kariya (JP)

(21) Appl. No.: 18/598,216

(22) Filed: Mar. 7, 2024

(30) Foreign Application Priority Data
Mar. 30, 2023 (JP) 2023-055573

(51) Int. Cl. H01M 8/02; H01M 8/04119

(52) U.S. Cl. CPC H01M 8/02; H01M 8/04141; H01M 2250/20

(57) ABSTRACT

A humidifier includes a humidifying unit that gives a dry gas supplied to a fuel cell moisture of a water-containing gas fed from the fuel cell, and a case that has an inflow port into which the dry gas flows and an outflow port from which a humidified gas generated by humidifying the dry gas in the humidifying unit flows out, and accommodates the humidifying unit, wherein the case includes a case body including an opening end portion, the case body accommodating the humidifying unit, and a lid body fixed to the opening end portion, and wherein a space through which the dry gas is allowed to flow is provided between the humidifying unit and the case body, and the space allows the inflow port to communicate with a gap between the humidifying unit and the case, the gap being opposite to the inflow port.

### CROSS REFERENCE TO RELATED APPLICATIONS

This application is based on and claims priority under 35 U.S.C. § 119 to Japanese Patent Application No. 2023-055573, filed on Mar. 30, 2023, the entire content of which is incorporated herein by reference.

### TECHNICAL FIELD

The present disclosure relates to a humidifier connected to a fuel cell.

### BACKGROUND DISCUSSION

In the related art, a humidifier used for preventing drying of a fuel cell mounted on a fuel cell electric vehicle (FCEV) or the like and maintaining an electrochemical reaction satisfactorily is known (see, for example, JP 2021-12873 A).

The humidifier described in JP 2021-12873 A includes a humidifying unit (a plate laminate in the literature) that gives moisture of water-containing gas fed from the fuel cell to a dry gas supplied to the fuel cell, and a case (a fluid channel housing in the literature) that accommodates the humidifying unit. A certain gap is provided between the plate side of the humidifying unit and the case so that the plate does not come into contact with the case due to vibration in the left-right direction.

By accommodating the humidifying unit in the case as in the humidifier described in JP 2021-12873 A, it is possible to reduce the fastening force between the plates of the humidifying unit. On the other hand, when a plurality of plates is stacked, due to a positional deviation between the plates or a molding error, the fastening force between the plates may increase or the fastening force may be biased for each plate. As a result, the humidifier may be vibrated in the left-right front-rear direction and the plate may be damaged.

A need thus exists for a humidifier which is not susceptible to the drawback mentioned above.

### SUMMARY

A humidifier includes a humidifying unit that gives a dry gas supplied to a fuel cell moisture of a water-containing gas fed from the fuel cell, and a case that has an inflow port into which the dry gas flows and an outflow port from which a humidified gas generated by humidifying the dry gas in the humidifying unit flows out, and accommodates the humidifying unit, wherein the case includes a case body including an opening end portion, the case body accommodating the humidifying unit, and a lid body fixed to the opening end portion, and wherein a space through which the dry gas is allowed to flow is provided between the humidifying unit and the case body, and the space allows the inflow port to communicate with a gap between the humidifying unit and the case, the gap being opposite to the inflow port.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram illustrating a humidified air supply unit and a fuel cell;

FIG. 2 is a front view of the humidified air supply unit;

FIG. 3 is an exploded perspective view of the humidified air supply unit;

FIG. 4 is a cross-sectional view taken along line IV-IV of FIG. 2;

FIG. 5 is a cross-sectional view taken along line V-V of FIG. 4; and

FIG. 6 is a perspective view showing a structure of a separator.

### DETAILED DESCRIPTION

Hereinafter, embodiments of the present disclosure will be described with reference to the drawings.

### [Basic Configuration]

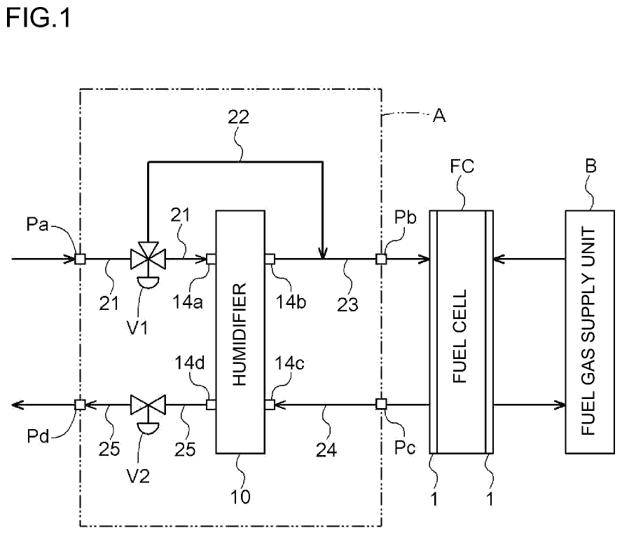

FIG. 1 illustrates a humidified air supply unit A that humidifies dry air (an example of dry gas: cathode gas) supplied to a cathode side of a fuel cell FC mounted on a vehicle and supplies the air as humidified air (an example of humidified gas).

A fuel cell FC has a structure in which a plurality of fuel cell cells (not shown) is sandwiched between a pair of end plates 1. In the fuel cell FC, hydrogen gas is supplied as fuel gas from a fuel gas supply unit B to the anode side, and humidified air is supplied as oxidant gas from a humidified air supply unit A to the cathode side.

The fuel cell FC generates electric power by an electrochemical reaction in the fuel cell when hydrogen gas is supplied and air (humidified air) is supplied. The fuel cell FC includes the humidified air supply unit A on one outer face of the pair of end plates 1.

In the fuel cell, high power generation performance is maintained by maintaining the polymer electrolyte membrane constituting the cathode side electrode in an appropriate wet state. For this reason, the humidified air supply unit A generates humidified air by giving moisture to dry air supplied from the outside, and supplies the humidified air to the cathode side of the fuel cell.

### [Humidified Air Supply Unit]

As shown in FIGS. 1 to 3, a humidifier 10 is fixed to the outer face of the end plate 1. The humidified air supply unit A includes an air supply port Pa to which pressurized dry air is supplied from an external compressor or the like, and a humidified air supply port Pb that supplies humidified air to the fuel cell FC. The humidifier 10 may be fixed to another support member without fixing the humidifier 10 to the outer face of the end plate 1.

The humidified air supply unit A includes a water-containing air inflow port Pc into which the water-containing air (an example of the water-containing gas) fed from the fuel cell FC flows, and a dehumidified air discharge port Pd that sends out dehumidified air obtained by removing moisture from the water-containing air. Specifically, the humidified air supply port Pb and the water-containing air inflow port Pc are formed in a hole shape in the end plate 1.

The humidifier 10 includes a dry air supply portion 14a to which dry air is supplied, a humidified air supply portion 14b that sends out humidified air, a water-containing air inflow portion 14c to which water-containing air is supplied from the fuel cell FC, and a dehumidified air discharge portion 14d that sends out dehumidified air.

The humidifier 10 generates humidified air by giving moisture contained in the water-containing air fed from the water-containing air inflow port Pc to the dry air supplied to the dry air supply portion 14a. The humidified air thus created is supplied from the humidified air supply portion 14b to the humidified air supply port Pb. In the humidifier 10, the water-containing air changes to dehumidified air by being deprived of moisture, and is discharged from the dehumidified air discharge port Pd. Details of the humidifier 10 will be described later.

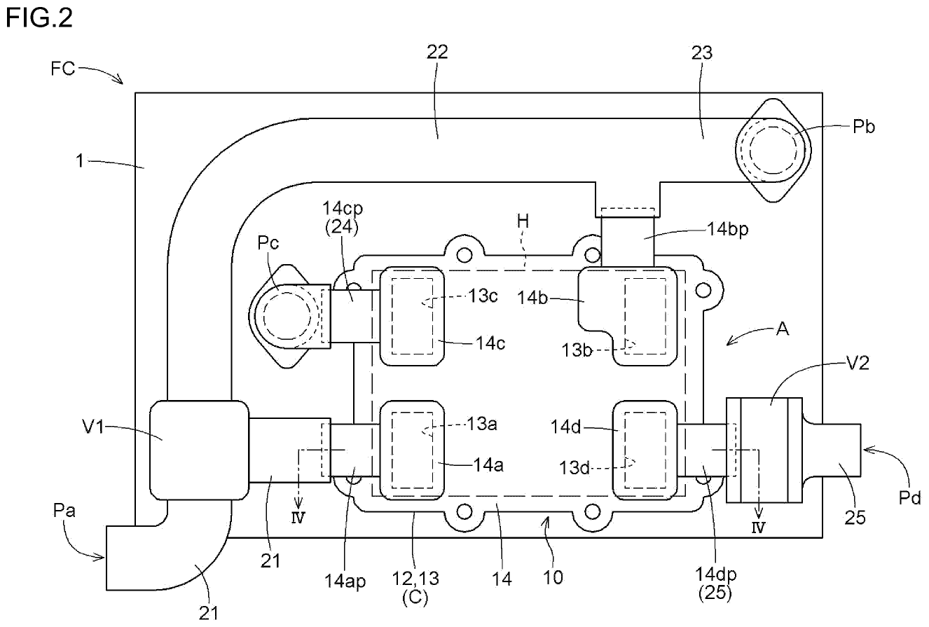

As illustrated in FIGS. 1 and 2, the humidified air supply unit A includes a dry air flow path 21 for supplying air from the air supply port Pa to the dry air supply portion 14a, a three-way valve V1 in the middle of the dry air flow path 21, and a branch flow path 22 branched by the three-way valve V1.

The humidified air supply unit A includes a humidified air supply path 23 that supplies the humidified air from the humidified air supply portion 14b to the humidified air supply port Pb, and the branch flow path 22 joins the humidified air supply path 23.

The humidified air supply unit A includes a water-containing air acquisition flow path 24 for sending the water-containing air from the water-containing air inflow port Pc to the water-containing air inflow portion 14c. Further, the humidified air supply unit A includes a dehumidified air discharge flow path 25 for sending the dehumidified air sent to the dehumidified air discharge portion 14d to the dehumidified air discharge port Pd, and includes a pressure regulating valve V2 in the middle of the dehumidified air discharge flow path 25.

### [Humidifier]

The humidifier 10 includes a case C and a humidifying unit H in which a plurality of separators 3 is stacked and accommodated in the case C. The humidifying unit H generates humidified air (an example of humidified gas) by giving moisture contained in water-containing air (an example of water-containing gas) fed from the fuel cell FC to dry air (an example of dry gas). The case C includes a case body 12 having an open end portion in the stacking direction in which the plurality of separators 3 is stacked, and a lid body 13 fixed so as to cover the opening end portion of the case body 12.

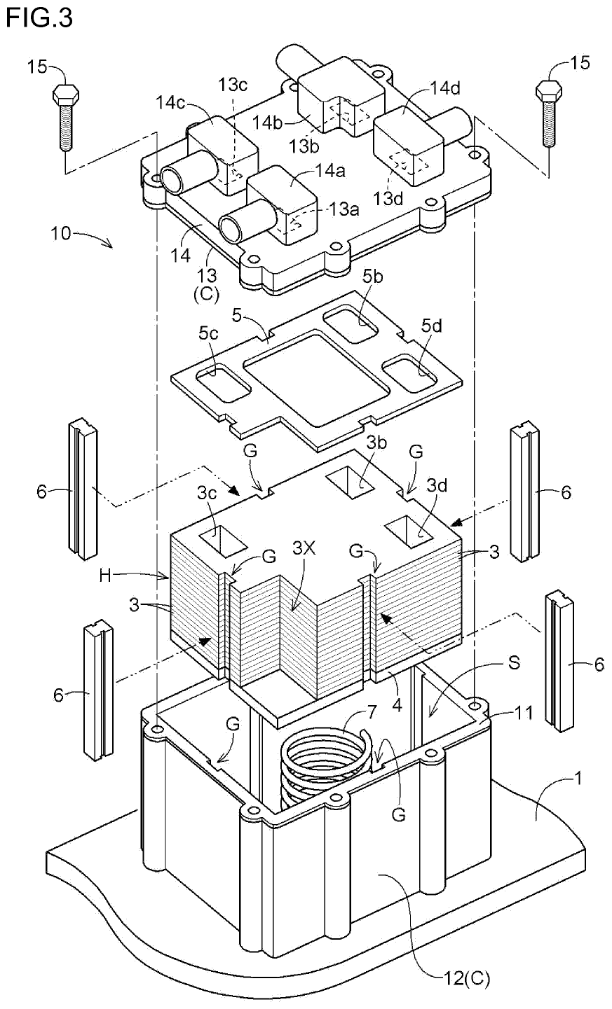

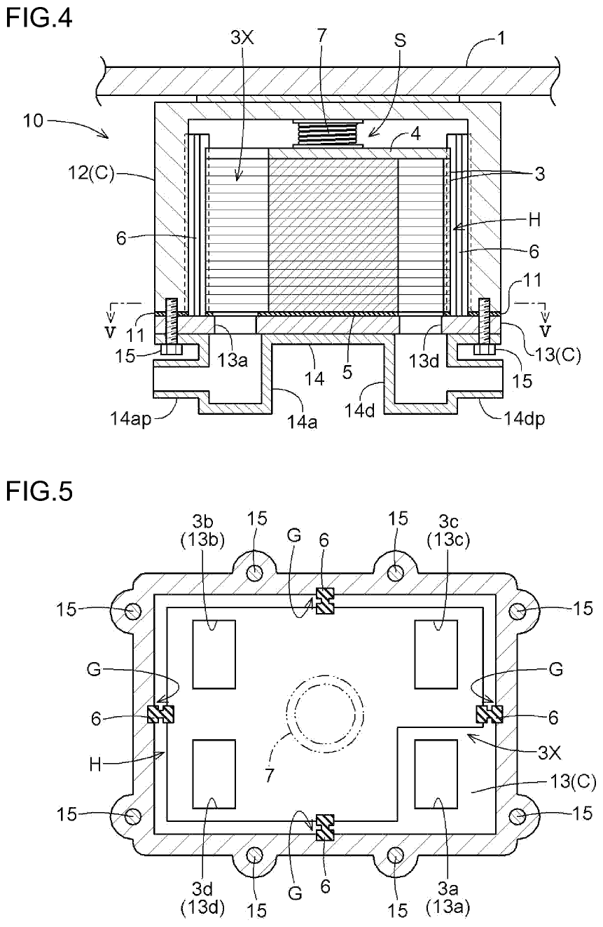

The case C includes an annular packing 11 (see FIG. 4) on a contact face between the case body 12 and the lid body 13, and is configured to be an airtight type that enables supply and discharge of air in the manifold 14 illustrated in FIG. 3 and prevents leakage of air by fastening the case body 12 and the lid body 13 with a plurality of bolts 15. The packing 11 may be fixed by bonding with at least one of the case body 12 and the lid body 13.

As shown in FIGS. 2 and 3, the lid body 13 includes a first port 13a (an example of an inflow port) into which dry air flows, a second port 13b (an example of an outflow port) that sends out humidified air, a third port 13c to which water-containing air is supplied, and a fourth port 13d from which dehumidified air is discharged in a form of a through hole shape in the lid body 13.

The lid body 13 includes a manifold 14 that supplies and discharges air to and from a position covering the outer face side. In the manifold 14, a dry air supply portion 14a communicating with the first port 13a (inflow port) is formed to bulge outward, and a dry gas supply cylinder 14ap is integrally formed in a communicating state.

In the manifold 14, the humidified air supply portion 14b communicating with the second port 13b (outflow port) is formed to bulge outward, and a humidified gas supply cylinder 14bp is integrally formed in a communicating state. In the manifold 14, the water-containing air inflow portion 14c communicating with the third port 13c is formed to bulge outward, and a gas inflow cylinder 14cp is integrally formed in a communicating state.

In the manifold 14, a dehumidified air discharge portion 14d communicating with the fourth port 13d is formed to bulge outward, and a gas discharge cylinder 14dp is integrally formed in a communicating state.

As illustrated in FIGS. 3 to 5, the plurality of separators 3 constituting the humidifying unit His accommodated in the internal space S (an example of a space) of the case body 12 in a stacked state. The internal space S communicates with the first port 13a, and the pressure of the dry air acts on the back face (the face opposite to the lid body 13) of the end plate 4, the back face being opposite to the first port 13a of the humidifying unit H. As described above, the pressure of the dry air acts on the back face of the end plate 4, whereby the plurality of separators 3 is maintained in a close contact state. The configuration will be described below.

### [Humidifier: Pressurization/Vibration Proofing of Separator]

As illustrated in FIGS. 3 and 4, the humidifying unit H includes a plurality of stacked separators 3, an end plate 4 disposed in contact with the separator 3, the end plate being opposite to the lid body 13, a seal 5 disposed between the lid body 13 and the separator 3, a plurality of vibration-proof members 6, and a compression coil spring 7 that lightly applies a biasing force in a direction in which the plurality of separators 3 is brought into pressure contact with each other.

In the humidifier 10, a bottom portion (a portion opposite to the opening end portion) of the case body 12 is connected to the end plate 1 of the fuel cell FC.

The separator 3 has a plate shape as a whole, and has a cutout portion 3X (an example of a space) formed by cutting out a region corresponding to the first port 13a. As a result, the dry air supplied to the first port 13a flows from the cutout portion 3X to the internal space S. The separator 3 has a second opening 3b, a third opening 3c, and a fourth opening 3d formed in a penetrating state at positions communicating with the second port 13b, the third port 13c, and the fourth port 13d, respectively.

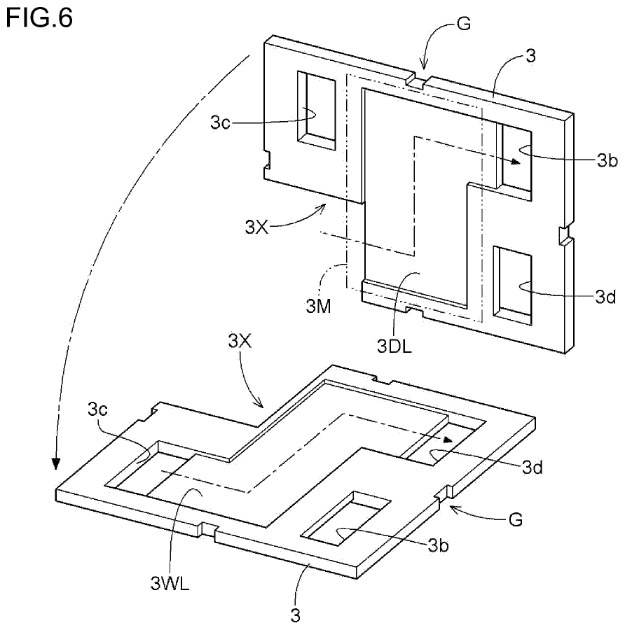

As shown in FIG. 6, the separator 3 has a drying flow path 3DL formed in a recessed shape in which dry air flows on one face (sometimes referred to as a drying flow path side). On the other hand, the separator 3 has a water-containing flow path 3WL formed in a recessed shape in which the water-containing air flows on the other face (also referred to as a water-containing flow path side).

The drying flow path 3DL enables gas to flow between the cutout portion 3X and the second opening 3b. In addition, the water-containing flow path 3WL enables gas to flow between the third opening 3c and the fourth opening 3d.

By moving the two separators 3 shown in FIG. 6 as indicated by arc-shaped arrows in FIG. 6, the separators stacked with each other, so that a water exchange membrane 3M is sandwiched between the drying flow path 3DL and the water-containing flow path 3WL. By stacking the plurality of separators 3 so as to overlap each other in this manner, the cutout portion 3X, the second opening 3b, the third opening 3c, and the fourth opening 3d communicate with each other, the cutout portion 3X and the second opening 3b communicate with each other, and the third opening 3c and the fourth opening 3d communicate with each other.

As illustrated in FIG. 3, the seal 5 has a second space 5b, a third space 5c, and a fourth space 5d formed in an opening shape at positions corresponding to the second opening 3b, the third opening 3c, and the fourth opening 3d.

In the humidifying unit H, the opposite face of the end plate 4 constituting the humidifying unit H is bonded to the inner face of the lid body 13 integrally with the seal 5.

With such a configuration, in the humidifying unit H, when the dry air supplied from the first port 13a flows to the drying flow path 3DL of the separator 3, the water-containing air flows to the water-containing flow path 3WL of the separator 3, whereby the moisture of the water-containing air is given to the dry air flowing to the drying flow path 3DL through the water exchange membrane 3M.

As a result, the humidified air is fed from the second port 13b and supplied from the humidified air supply port Pb to the fuel cell FC. The dehumidified air is fed from the fourth port 13d and discharged from the dehumidified air discharge port Pd.

As illustrated in FIGS. 3 and 4, the vibration-proof member 6 is made of rubber, a flexibly deformable resin material, or the like, and is disposed in a state of being fitted in the plurality of recessed grooves G on the inner face of the case body 12 and the plurality of recessed grooves G on the outer periphery of the separator 3.

The plurality of vibration-proof members 6 has a vibration-proof function of attenuating vibration acting on the separator 3 from the outside.

The compression coil spring 7 lightly applies a biasing force in a direction in which the plurality of separators 3 comes into contact with each other. This biasing force is such that the plurality of separators 3 is lightly brought into contact with each other, and suppresses separation of the plurality of separators 3 even in a situation where vibration acts from the outside.

In the humidifier 10, the dry air sequentially flowing from the dry air flow path 21 to the dry air supply portion 14a and the first port 13a is supplied from the cutout portion 3X of the separator 3 to the internal space S of the case C. Most of the dry air supplied in this manner flows into the drying flow path 3DL and is humidified to change into humidified air and is fed from the humidified air supply portion 14b.

On the other hand, the dry air that has not flowed into the drying flow path 3DL applies pressure from the outer end face of the end plate 4 in a direction in which the plurality of separators 3 is brought into pressure contact with each other. As a result, the plurality of separators 3 is maintained in a pressure contact state. The force for bringing the plurality of separators 3 into pressure contact with each other by the dry air is set to a value larger than the biasing force of the compression coil spring 7.

### [Action and Effect of the Embodiment]

In this manner, the plurality of separators 3 can be maintained in the pressure contact state by supplying the pressurized air supplied from the compressor or the like from the first port 13a to the internal space S of the humidifier 10. Therefore, it is not necessary to maintain high dimensional accuracy as compared with the configuration in which the pressure contact state is maintained by the mechanical mechanism using the fastening force, and it is not necessary to increase the strength of the case body 12 and the lid body 13 so as to withstand the fastening force.

In addition, the humidifier 10 can cope with a dimensional error between the case C and the humidifying unit H, and for example, even when there is a slight dimensional error, the humidifying unit H can be accommodated in the internal space S of the case body 12 constituting the case C, and the lid body 13 constituting the case body 12 can be connected and fixed to the case body 12.

Specifically, in the configuration using the pressure of the pressurized air as described above, the pressure acts on the entire surface of the end plate 4, so that it is also possible to maintain the pressure contact state by applying uniform pressure to the plurality of separators 3.

The plurality of separators 3 may not be linearly stacked in the overlapping direction and may be inclined with respect to the overlapping direction due to individual differences. Even when the plurality of separators 3 cannot be stacked in an appropriate posture as described above, it is possible to maintain the plurality of separators 3 in an overlapping state in a state where pressure is applied to the plurality of separators 3 by utilizing the pressure of the pressurized air. In addition, in this configuration, the pressure distribution is not uneven unlike the configuration in which the mechanical fastening force is applied, and the durability can be improved.

In the humidifier 10, a gap is formed between the inner face of the case body 12 and the outer periphery of the plurality of separators 3, and a vibration-proof member 6 is provided between the inner face of the case body 12 and the outer periphery of the plurality of separators 3. As a result, when vibration acts from the outside, inconvenience that the inner face of the case body 12 and the outer periphery of the separator 3 are in direct contact with each other is suppressed, and the vibration-proof member 6 attenuates the vibration.

The plurality of vibration-proof members 6 is provided between the case body 12 and the outer periphery of the plurality of separators 3. Therefore, even when vibration acts in a direction orthogonal to the stacking direction of the separators 3, damage due to abutment between the inner face of the case body 12 and the outer periphery of the separators 3 is prevented, and there is no disadvantage of changing the positional relationship of the plurality of separators 3 due to damping of vibration.

Since the compression coil spring 7 applies a biasing force to the extent that the plurality of separators 3 is lightly brought into contact with each other, it is not necessary to increase the strength of the case C so as to withstand the biasing force. Even when vibration acts from the outside in a situation where pressurized air is not supplied, separation of the plurality of separators 3 is suppressed by the biasing force of the compression coil spring 7.

Since the case C and the humidifying unit H have a configuration capable of coping with dimensional errors, even when the humidifying unit H is bonded and fixed to the lid body 13 in a form of sandwiching the seal 5, it is not necessary to increase the bonding accuracy.

By forming the cutout portion 3X having a shape in which part of the plurality of separators 3 of the humidifying unit H is cut out and supplying pressurized dry air from the first port 13a (inflow port) to the cutout portion 3X, the cutout portion 3X can be used as both the supply of air for pressurization and the supply of dry air, and the humidifier 10 can be downsized.

### Another Embodiment

The present disclosure may be configured as follows in addition to the above-described embodiment (those having the same functions as those in the embodiment are designated by the same number and reference numeral as those in the embodiment).
(a) Instead of the compression coil spring 7, a vibration-proof member such as rubber or flexibly deformed resin is used. It is also conceivable to use the vibration-proof member and the compression coil spring 7 in combination.
(b) The vibration-proof member 6 does not need to be in contact with all the separators 3, and can be disposed, for example, so as to be in contact with part of the plurality of separators 3. Further, the vibration-proof member 6 may be configured to be brought into contact with only the end plate 4.

That is, the plurality of separators 3 is in contact with each other in a stacked state. Therefore, even when an external force acts in a direction intersecting the stacking direction, the positional relationship between the separators 3 is not easily changed by the holding force (frictional force or adhesive force) acting between the separators 3 adjacent in the stacking direction. For this reason, it is also conceivable to arrange the vibration-proof member 6 so as to attenuate an external force acting on part of the separators 3 or the end plate 4 as in another embodiment (b). Note that a rubber gasket, an adhesive, an adhesive sheet, and the like may be sandwiched between the plurality of separators 3, and it is possible to obtain frictional force and adhesive force by these members.

The vibration-proof member 6 according to the another embodiment (b) is not limited to rubber or resin, but a metal material such as a spring plate or a torsion spring can be used, and the vibration-proof member 6 may be configured by a combination of such a spring material and rubber or resin.
(c) As the vibration-proof member 6, it is also conceivable to provide an annular rubber or resin so as to be in contact with the entire circumference of the end plate 4 and the inner circumference of the case body 12. When the annular vibration-proof member 6 is used, in order to supply dry air supplied from the first port 13a to the back face (the face opposite to the lid body 13) of the end plate 4, it is necessary to cut out part of the vibration-proof member 6 to provide a flow path through which pressurized air flows, or to form a dedicated flow path through which pressurized air flows on the inner face of the case body 12 or the outer periphery of the separator 3.
(d) Instead of the cutout portion 3X formed in the separator 3, for example, a through hole through which dry air supplied from the first port 13a flows to the drying flow path 3DL is formed, and a flow space through which dry air supplied from the first port 13a is supplied to the internal space S of the case C is formed.

As a specific configuration of the another embodiment (d), a flow space having a structure penetrating the plurality of separators 3 in a stacked state and a flow space formed in a groove shape on the inner face of the case body 12 can be considered.

Note that the configuration disclosed in the above-described embodiments (including the another embodiment, the same applies hereinafter) can be applied in combination with the configuration disclosed in other embodiments as long as there is no contradiction, and the embodiments disclosed in the present specification are an example, and the embodiments of the present disclosure are not limited thereto, and can be appropriately modified without departing from the object of the present disclosure.

The present disclosure can be used in a humidifier that humidifies a gas on a cathode side of a fuel cell.

A humidifier includes a humidifying unit that gives a dry gas supplied to a fuel cell moisture of a water-containing gas fed from the fuel cell, and a case that has an inflow port into which the dry gas flows and an outflow port from which a humidified gas generated by humidifying the dry gas in the humidifying unit flows out, and accommodates the humidifying unit, wherein the case includes a case body including an opening end portion, the case body accommodating the humidifying unit, and a lid body fixed to the opening end portion, and wherein a space through which the dry gas is allowed to flow is provided between the humidifying unit and the case body, and the space allows the inflow port to communicate with a gap between the humidifying unit and the case, the gap being opposite to the inflow port.

In this configuration, a space is provided between the humidifying unit and the case body, and the space allows the inflow port to communicate with a gap (fuel cell side) between the humidifying unit and the case, the gap being opposite to the inflow port. Therefore, even when there is a dimensional error in the humidifying unit, it is possible to cope with the dimensional error in the left-right front-rear direction using this space. As a result, it is possible to connect the case body with the lid body without being disturbed by the humidifying unit in a state where the humidifying unit is accommodated in the case body.

Moreover, in this configuration, a high-pressure dry gas flows through a space between the humidifying unit and the case body in the present configuration, and the space allows the inflow port to communicate with the fuel cell side. That is, the closed space between the humidifying unit and the case body is pressurized by the dry gas. Therefore, even when the humidifier is subjected to vibration or the like in the left-right front-rear direction, the dry gas exerts a cushion function, and damage to the humidifying unit can be prevented. As described above, the humidifier can cope with dimensional errors and has high durability.

In the humidifier, an end portion of the humidifying unit is bonded to the lid body.

In this configuration, when the humidifying unit and the lid body are bonded to each other as in the present configuration, the posture of the humidifying unit can be stabilized as compared with the case where the seal member is interposed as in the related art. In addition, since it is possible to cope with the dimensional error of the humidifying unit using the space described above, bond accuracy is not required, and the humidifying unit and the lid body can be easily bonded.

In the humidifier, a separator of the humidifying unit has a cutout forming the space communicating with the inflow port.

In this configuration, when the cutout provided in the separator of the humidifying unit functions as the above-described space and communicates with the inflow port, the cutout space can also be used as a flow space of the dry gas in the humidifying unit, so that the humidifier can be made compact.

In the humidifier, a vibration-proof member is disposed between the humidifying unit and the case body.

In this configuration, when the vibration-proof member is disposed between the humidifying unit and the case body as in the present configuration, damage to the humidifying unit due to vibration or the like can be reliably prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A humidifier comprising:
a humidifying unit that gives a dry gas supplied to a fuel cell moisture of a water-containing gas fed from the fuel cell; and
a case that has an inflow port into which the dry gas flows and an outflow port from which a humidified gas generated by humidifying the dry gas in the humidifying unit flows out, and accommodates the humidifying unit, wherein
the case includes a case body including an opening end portion, the case body accommodating the humidifying unit, and a lid body fixed to the opening end portion, and wherein a space through which the dry gas is allowed to flow is provided between the humidifying unit and the case body, and the space allows the inflow port to communicate with a gap between the humidifying unit and the case, the gap being opposite to the inflow port.

2. The humidifier according to claim 1, wherein an end portion of the humidifying unit is bonded to the lid body.

3. The humidifier according to claim 1, wherein a separator of the humidifying unit has a cutout forming the space communicating with the inflow port.

4. The humidifier according to claim 2, wherein a separator of the humidifying unit has a cutout forming the space communicating with the inflow port.

5. The humidifier according to claim 1, wherein a vibration-proof member is disposed between the humidifying unit and the case body.

6. The humidifier according to claim 2, wherein a vibration-proof member is disposed between the humidifying unit and the case body.
